(19) United States
(12) Patent Application Publication
(10) Pub. No.: US 2017/0329052 A1
(43) Pub. Date: Nov. 16, 2017

(54) SILICONE HYDROGEL COMPOSITION AND LENSES MADE OF THE COMPOSITION

(71) Applicant: Chien Ching CHAN, Hsinchu County (TW)

(72) Inventor: Chien Ching CHAN, Hsinchu County (TW)

(21) Appl. No.: 15/186,155

(22) Filed: Jun. 17, 2016

(30) Foreign Application Priority Data
May 12, 2016 (TW) 105114684

(51) Int. Cl. G02B 1/04

(52) U.S. Cl. CPC G02B 1/043

(57) ABSTRACT

A silicone hydrogel composition including a hydrophilic monomer and a first silicon compound is disclosed. The hydrophilic monomer is selected from the group consisting of N,N-dimethylacrylamide (DMA), N-vinylpyrrolidone (NVP) and 2-hydroxyethyl methacrylate (HEMA). The first silicon compound is (3-methacryloxy-2-hydroxypropoxy)propylbis(trimethylsiloxy)methylsilane (SiGMA). The weight percentage of the hydrophilic monomer is 25% to 70%, and the weight percentage of the first silicon compound is 5% to 50%. In the hydrophilic monomer, the weight percentage of a total amount of N-vinylpyrrolidone and N,N-dimethylacrylamide is 25% to 55%. An embodiment of the present disclosure discloses a silicone hydrogel lens, which is made by the above-mentioned silicon hydrogel composition, has a Young's modulus less than 2.0 MPa, and can effectively improve the lens wearing comfort of a user.

### TECHNICAL FIELD

The present disclosure relates to a silicone hydrogel composition and lenses made of the composition, and more particularly, to a silicone hydrogel composition including a hydrophilic monomer, a silicon compound and a silicone hydrogel lens with a low Young's modulus made of the composition.

### DISCUSSION OF THE BACKGROUND

Since a contact lens made of silicone hydrogel has high oxygen permeability (Dk, oxygen permeability coefficient), sufficient amounts of oxygen can directly penetrate the lens to contact the cornea of an eye, thereby providing the cornea with appropriate oxygen content. One added benefit is that, even if the lens has been worn for a long time, eye discomfort caused by corneal hypoxia barely occurs. Therefore, silicone hydrogel has been one of the better options for contact lenses. However, people wearing the silicone hydrogel lenses still feel uncomfortable, and thus the mechanical property of the contact lenses made by conventional methods needs to be improved.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY

One aspect of the present disclosure provides a silicone hydrogel composition including a hydrophilic monomer and a silicon compound, and a silicone hydrogel lens with a low Young's modulus made of the composition. When the lens of the present invention is worn by a user, the lens keeps high moisture (water content) and high oxygen permeability (Dk, oxygen permeability coefficient), and the characteristic of a low Young's modulus can effectively improve the user's lens wearing comfort.

According to this aspect of the present disclosure, a silicone hydrogel composition comprises a hydrophilic monomer and a first silicon compound, wherein the hydrophilic monomer is selected from the group consisting of N,N-dimethylacrylamide (DMA), N-vinylpyrrolidone (NVP) and 2-hydroxyethyl methacrylate (HEMA), wherein the first silicon compound is (3 -methacryloxy-2 -hydroxypropoxy)propylbis(trimethylsiloxy)methylsilane (SiGMA), wherein the weight percentage of the hydrophilic monomer is 25% to 70%, and the weight percentage of the first silicon compound is 5% to 50%, and wherein in the hydrophilic monomer, the weight percentage of the total amount of N-vinylpyrrolidone and N,N-dimethylacrylamide is 25% to 55%.

In an embodiment of the present disclosure, the silicone hydrogel composition further includes a second silicon compound, which has a chemical structure of any one of formulae (1) to (5):

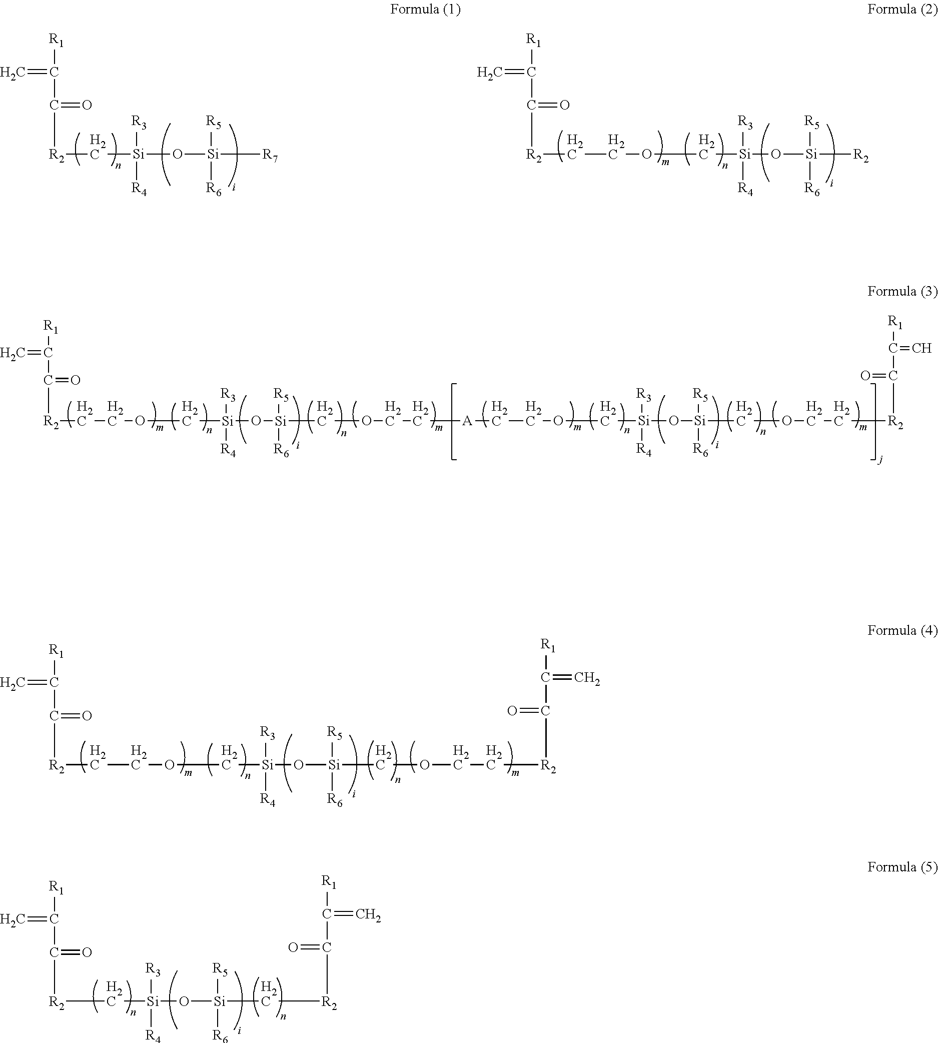

In the above formulae (1) to (5), A represents OOCNH—R₇—NHCOO, R₁ represents H or CH₃, R₂ represents OCH₂CH₂NHCOO or O, R₃, R₄, R₅ and R₆ represent CH₃ or OSi(CH₃)₃, R₇ represents alkyl, n is between 3 and 5, m is between 1 and 20, i is between 1 and 25, and j is between 1 and 10.

In an embodiment of the present disclosure, the weight percentage of the second silicon compound is less than 50%.

In an embodiment of the present disclosure, the silicone hydrogel composition further includes a crosslinking agent which is to selected from the group consisting of ethylene glycol dimethacrylate, poly(diethylene glycol) dimethacrylate, triethylene glycol dimethacrylate, 1,4-butylene glycol dimethacrylate, trimethylolpropane trimethacrylate, pentaerythritol tetramethacrylate, bisphenol A dimethacrylate, methylene bismethylacrylamide, divinyl ether, divinyl sulfone, divinyl benzene, trivinyl benzene, triallyl isocyanurate, triallyl phthalate, diallyl phthalate, allyl methacrylate, and a combination thereof.

In an embodiment of the present disclosure, the weight percentage of DMA to (DMA+NVP) is more than 12.5%.

In an embodiment of the present disclosure, the weight percentage of DMA to (DMA+NVP) is more than 25.0%.

In an embodiment of the present invention, the silicone hydrogen composition further includes a colored monomer or a colored compound.

In an embodiment of the present disclosure, the silicone hydrogel composition further includes a thermal initiator, which is selected from the group consisting of azobisdimethylvaleronitrile (ADVN), 2,2′-azobisisobutyronitrile (AIBN), 2,2′-azobis(2,4-dimethylvaleronitrile), 2,2′-azobis(2-methylpropanenitrile) and 2,2′-azobis(2-methyl)valeronitrile.

In an embodiment of this disclosure, the silicone hydrogel composition further includes a light initiator, which is selected from the group consisting of 2-hydroxy-2-methylpropiophenone, 1-hydroxycyclohexyl phenyl ketone, 2,2-dimethoxy-2-phenylacetophenone, benzoin methyl ether, and 2,2-diethoxyacetophenone.

An embodiment of the present disclosure discloses a silicone hydrogel lens, which is made of any one of the previous silicon hydrogel compositions, and the lens has a Young's modulus smaller than 2.0 MPa.

In an embodiment of present disclosure, the water content of the lens is not less than 47%, the Young's modulus of the lens is not more than 0.85 MPa, and the Dk value of the lens is not less than 50.

In an embodiment of the present disclosure, the second silicon compound has the chemical structure of formula (1), the water content of the lens is not less than 34%, the Young's modulus of the lens is not more than 1.9 MPa, and the Dk value of the lens is not less than 58.

In an embodiment of the present disclosure, the second silicon compound has the chemical structure of formula (2), the water content of the lens is not less than 40%, the Young's modulus of the lens is not more than 1.25 MPa, and the Dk value of the lens is not less than 76.

In an embodiment of the present disclosure, the second silicon compound has the chemical structure of formula (3), the water content of the lens is not less than 36%, the Young's modulus of the lens is not more than 1.10 MPa, and the Dk value of the lens is not less than 45.

In an embodiment of the present disclosure, the second silicon compound has the chemical structure of formula (3), the water content of the lens is not less than 43%, the Young's modulus of the lens is not more than 0.66 MPa, and the Dk value of the lens is not less than 53.

In an embodiment of the present disclosure, the second silicon compound has the chemical structure of formula (3), the water content of the lens is not less than 42%, the Young's modulus of the lens is not more than 0.65 MPa, and the Dk value of the lens is not less than 50.

In an embodiment of the present disclosure, the second silicon compound has the chemical structure of formula (4), the water content of the lens is not less than 60%, the Young's modulus of the lens is not more than 0.41 MPa, and the Dk value of the lens is not less than 55.

In an embodiment of the present disclosure, the second silicon compound has the chemical structure of formula (5), the water content of the lens is not less than 41%, the Young's modulus of the lens is not more than 1.20 MPa, and the Dk value of the lens is not less than 47.

In an embodiment of the present disclosure, the second silicon compound has the chemical structure of formula (1), the water content of the lens is not less than 48%, the Young's modulus of the lens is not more than 0.70 MPa, and the Dk value of the lens is not less than 80.

The lens is made of the silicone hydrogel composition in the embodiments of the present disclosure, wherein the weight percentage of DMA to (DMA+NVP) is more than 12.5%, the water content of the lens is more than 34%, the Young's modulus of the lens is less than 2.0 MPa, and the Dk value of the lens is more than 50. Thus, when the lens is worn by a user, the lens keeps high moisture (water content) and high oxygen permeability (Dk, oxygen permeability coefficient), and the low Young's modulus of the lens can also effectively improve the lens wearing comfort of the user.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### DETAILED DESCRIPTION

The following description of the disclosure illustrates embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a silicone hydrogel composition and lenses made of the composition. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

Silicone Hydrogel Composition

An embodiment of the present disclosure discloses a silicone hydrogel composition including a hydrophilic monomer and a first silicon compound, wherein the hydrophilic monomer is selected from the group consisting of N,N-dimethylacrylamide (DMA), N-vinylpyrrolidone (NVP) and 2-hydroxyethyl methacrylate (HEMA), wherein the first silicon compound is (3-methacryloxy-2-hydroxypropoxy)propylbis(trimethylsiloxy)methylsilane (SIGMA), wherein the weight percentage of the hydrophilic monomer is 25% to 70%, and the weight percentage of the first silicon compound is 5% to 50%, and wherein in the hydrophilic monomer, the weight percentage of the total amount of N-vinylpyrrolidone and N,N-dimethylacrylamide is 25% to 55%.

In an embodiment of the present disclosure, the silicone hydrogel composition further includes a second silicon compound, which has a chemical structure of any one of the following formulae (1) to (2):

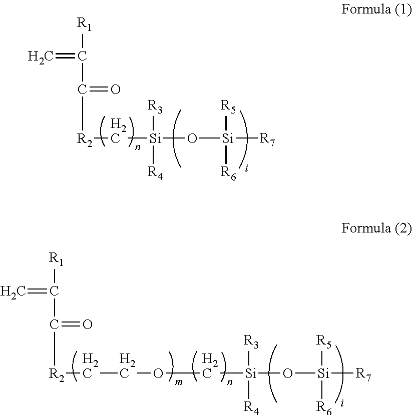

In the above formulae (1) to (2), R₁ represents H or CH₃, R₂ represents OCH₂CH₂NHCOO or O, R₃, R₄, R₅ and R₆ represent CH₃ or OSi(CH₃)₃, R₇ represents alkyl, n is between 3 and 5, m is between 1 and 20, and i is between 1 and 25. In an embodiment of the present disclosure, the weight percentage of the second silicon compound is less than 50%.

In an embodiment of the present disclosure, the silicone hydrogel composition further includes a second silicon compound, which has a chemical structure of any one of the following formulae (3) to (5):

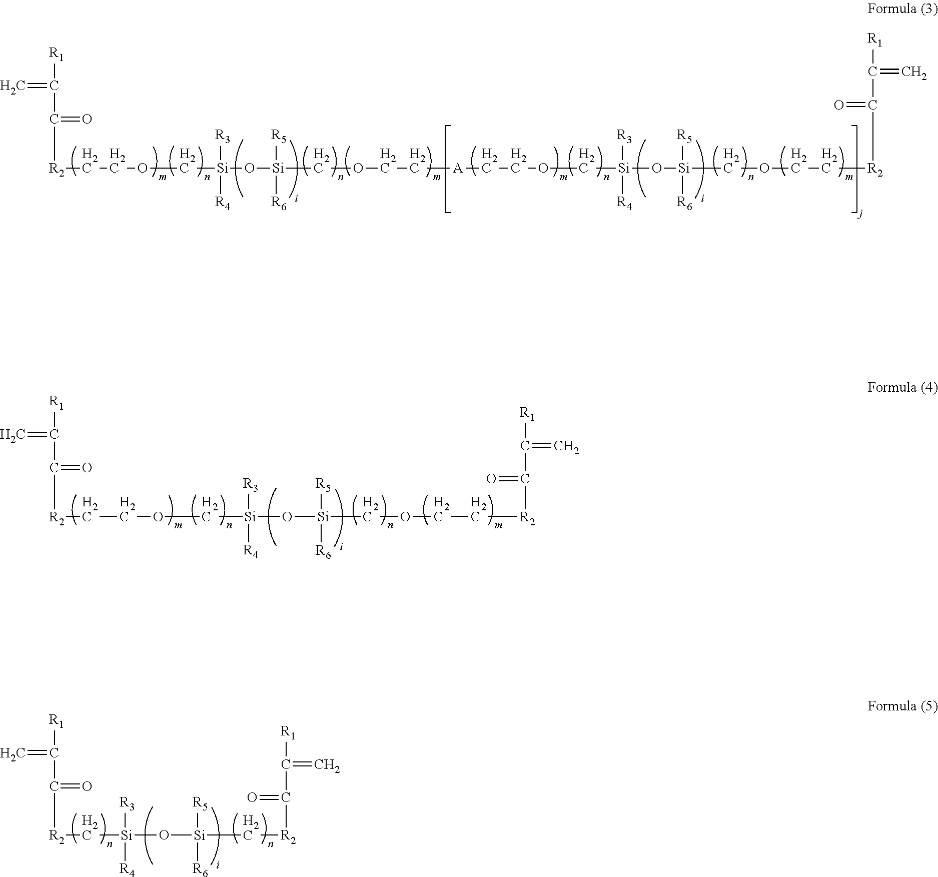

In the above formulae (3) to (5), A represents OOCNH—R₇—NHCOO, R₁ represents H or CH₃, R₂ represents OCH₂CH₂NHCOO or O, R₃, R₄, R₅ and R₆ represent CH₃ or OSi(CH₃)₃, R₇ represents alkyl, n is between 3 and 5, m is between 1 and 20, i is between 1 and 25, and j is between 1 and 10. In an embodiment of the present disclosure, the weight percentage of the second silicon compound is less than 50%.

In an embodiment of the present disclosure, the silicone hydrogel composition further includes a crosslinking agent which is selected from the group consisting of ethylene glycol dimethacrylate, poly(diethylene glycol) dimethacrylate, triethylene glycol dimethacrylate, 1,4-butylene glycol dimethacrylate, trimethylolpropane trimethacrylate, pentaerythritol tetramethacrylate, bisphenol A dimethacrylate, methylene bismethylacrylamide, divinyl ether, divinyl sulforte, divinyl benzene, trivinyl benzene, triallyl isocyanurate, triallyl phthalate, diallyl phthalate, allyl methacrylate, and a combination thereof.

In an embodiment of the present disclosure, the silicone hydrogel composition further includes a colored monomer or a colored compound, such as a blue monomer. In an embodiment of the present disclosure the silicone hydrogel composition further includes a thermal initiator, which is selected from the group consisting of azobisdimethylvaleronitrile (ADVN), 2,2′-azobisisobutyronitrile (AIBN), 2,2′-azobis(2,4-dimethylvaleronitrile), 2,2′-azobis(2-methylpropanenitrile) and 2,2′-azobis(2-methyl)valeronitrile. In an embodiment of the present disclosure, the silicon hydrogel composition further includes a light initiator, which is selected from the group consisting of 2-hydroxy-2-methylpropiophenone, 1-hydroxycyclohexyl phenyl ketone, 2,2-dimethoxy-2-phenylacetophenone, benzoin methyl ether, and 2,2-diethoxyacetophenone.

Silicone Hydrogel Lens

An embodiment of the present disclosure discloses a silicone hydrogel lens, which is made of the silicon hydrogel composition described in the previous descriptions. When the lens is worn by a user, the lens keeps high moisture (water content) and high oxygen permeability (Dk, oxygen permeability coefficient), and the low Young's modulus of the lens, which is less than 2.0 MPa, can also effectively solve the problem of the user feeling uncomfortable when wearing the lens. It is well-known knowledge in the art of the present disclosure to use a silicone hydrogel composition for preparing a silicone hydrogel lens. For example, Taiwanese Patent Application Publication No. 201339188 discloses the technology for preparing a lens, and is incorporated entirely herein for reference.

In the present disclosure, the test methods for the characteristics such as moisture (water content), oxygen permeability (Dk, oxygen permeability coefficient) and comfort (Young's modulus) of the lens are the well-known knowledge in the art of the present disclosure, e.g., Taiwanese Patent Application Publication No. 201339188, which is entirely incorporated herein for reference. In the following descriptions, the tests are performed by the above methods for objectively evaluating moisture (water content), oxygen permeability (Dk, oxygen permeability coefficient) and comfort (Young's modulus) of the lens in the embodiment of the present invention. The test results of the lens in the embodiment of the present invention are shown in the following tables.

In an embodiment of the present disclosure, the method for preparing a silicone hydrogel lens includes: injecting a silicone hydrogel composition into a mold for preparing a lens, and performing a curing treatment for polymerization of the silicone hydrogel composition in the mold so as to form a main body of a lens.

In Embodiment 1 of the present disclosure, the constituents and weight percentages thereof in the silicone hydrogel composition are shown below.

| Embodiment 1 | Weight percentage |
|---|---|
| First silicon compound (SiGMA) | 48.3 |
| Hydrophilic monomer (HEMA) | 18.6 |
| Hydrophilic monomer | 32.7 |
| (DMA + NVP) | |
| Crosslinking agent (EGDMA) | 0.4 |
| Initiator (1173) | 0.7 |

In Embodiment 1 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 1 was used, and when the weight percentage of DMA to (DMA+NVP) is controlled to be more than 12.5%, the water content of the lens was not less than 47%, the Young's modulus of the lens was not more than 0.85 MPa, and the Dk value of the lens was not less than 50. It is known that when the Young's modulus of the lens is less than 2.0 MPa, the problem of lens discomfort is solved. In Embodiment 1 of the present disclosure, the Young's modulus is not more than 0.85 MPa, and it is apparent that the lens wearing comfort of a user can be effectively improved.

Embodiment 1

| DMA/(DMA + NVP) % | 0 | 12.5% | 25% | 50% | 75% | 100% |
|---|---|---|---|---|---|---|
| Water content (%) | 38 | 47 | 49 | 51 | 51 | 52 |
| Young's modulus | 1.66 | 0.85 | 0.67 | 0.46 | 0.4 | 0.36 |
| (MPa) | | | | | | |
| Oxygen permeability | 57 | 50 | 53 | 54 | 57 | 53 |
| coefficient (Dk) | | | | | | |

In Embodiment 2 of the present disclosure, the constituents and weight percentages thereof in the silicone hydrogel composition and the functional groups of the second silicon compound (Formula (1)) are shown in the following table in detail.

| Embodiment 2 | Weight percentage |
|---|---|
| First silicon compound (SiGMA) | 26.9 |
| Hydrophilic monomer (HEMA) | 15.4 |
| Hydrophilic monomer | 29.8 |
| (DMA + NVP) | |
| Crosslinking agent (EGDMA) | 1 |
| Initiator (1173) | 0.7 |
| Second silicon compound | 26.9 |
| (Formula (1)) | |
| R1 | CH₃ |
| R2 | O |
| R3 | OSi(CH₃)₃ |
| R4 | OSi(CH₃)₃ |
| R5 | CH₃ |
| R6 | CH₃ |
| R7 | CH₃ |
| n | 3 |
| i | 1 |

In Embodiment 2 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 2 was used, and when the weight percentage of DMA to (DMA+NVP) is controlled to be more than 12.5%, the water content of the lens was not less than 34%, the Young's modulus of the lens was not more than 1.9 MPa, and the Dk value of the lens was not less than 58. It is known that when the Young's modulus of the lens is less than 2.0 MPa, the problem of lens discomfort is solved. In Embodiment 2 of the present disclosure, the Young's modulus is not more than 1.9 MPa, and obviously, the problem of lens discomfort can apparently be solved. In other words, when the weight percentage of DMA to (DMA±NVP) is controlled to be not less than 25% and the Young's modulus of the lens is further decreased to be not more than 1.77 MPa, the lens wearing comfort of a user can be more effectively improved.

Embodiment 2 (second silicon compound: Formula (1))

| DMA/(DMA + NVP) % | 0 | 12.5% | 25% | 50% | 75% | 100% |
|---|---|---|---|---|---|---|
| Water content (%) | 29 | 34 | 37 | 39 | 39 | 39 |
| Young's modulus | 2.13 | 1.9 | 1.77 | 1.22 | 0.98 | 0.65 |
| (MPa) | | | | | | |
| Oxygen permeability | 56 | 58 | 63 | 63 | 65 | 61 |
| coefficient (Dk) | | | | | | |

In Embodiment 3 of the present disclosure, the constituents and weight percentages thereof in the silicone hydrogel composition and the functional groups of the second silicon compound (Formula (2)) are shown in the following table in detail.

| Embodiment 3 | Weight percentage |
|---|---|
| First silicon compound (SiGMA) | 26.9 |
| Hydrophilic monomer(HEMA) | 15.4 |
| Hydrophilic monomer | 29.8 |
| (DMA + NVP) | |
| Crosslinking agent (EGDMA) | 1 |
| Initiator (1173) | 0.7 |
| Second silicon compound | 26.9 |
| (Formula (2)) | |
| R1 | CH₃ |
| R2 | OCH₂CH₂NHCOO |
| R3 | CH₃ |
| R4 | CH₃ |
| R5 | CH₃ |
| R6 | CH₃ |
| R7 | C₄H₉ |
| m | 1 |
| n | 3 |
| i | 12 |

In Embodiment 3 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 3 was used, and when the weight percentage of DMA to (DMA+NVP) is controlled to be more than 12.5%, the water content of the lens was not less than 40%, the Young's modulus of the lens was not more than 1.25 MPa, and the Dk value of the lens was not less than 76. It is known that when the Young's modulus of the lens is less than 2.0 MPa, the problem of lens discomfort is solved. In Embodiment 3 of the present disclosure, the Young's modulus is not more than 1.25 MPa, and it is apparent that the lens wearing comfort of a user can be effectively improved.

Embodiment 3 (second silicon compound: Formula (2))

| DMA/(DMA + NVP) % | 0 | 12.5% | 25% | 50% | 75% | 100% |
|---|---|---|---|---|---|---|
| Water content (%) | 37 | 40 | 42 | 43 | 44 | 45 |
| Young's modulus | 3.63 | 1.25 | 1.04 | 0.86 | 0.71 | 0.79 |
| (MPa) | | | | | | |
| Oxygen permeability | 82 | 80 | 84 | 76 | 79 | 81 |
| coefficient (Dk) | | | | | | |

In Embodiment 4 of the present disclosure, the constituents and weight percentages thereof in the silicone hydrogel composition and the functional groups of the second silicon compound (Formula (3)) are shown in the following table in detail.

| Embodiment 4 | Weight percentage |
|---|---|
| First silicon compound (SiGMA) | 17.5 |
| Hydrophilic monomer (HEMA) | 11.2 |
| Hydrophilic monomer | 51.7 |
| (DMA + NVP) | |
| Initiator (1173) | 0.7 |
| Second silicon compound | 19.6 |
| (Formula (3)) | |
| R1 | CH₃ |
| R2 | OCH₂CH₂NHCOO |
| R3 | CH₃ |
| R4 | CH₃ |
| R5 | CH₃ |
| R6 | CH₃ |
| R7 | C₄H₈ |
| A | OOCNH—R7—NHCOO |
| m | 1 |
| n | 3 |
| i | 17 |
| j | 3 |

In Embodiment 4 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 4 was used, and when the weight percentage of DMA to (DMA+N VP) is controlled to be more than 12.5%, the water content of the lens was not less than 36%, the Young's modulus of the lens was not more than 1.10 MPa, and the Dk value of the lens was not less than 45. It is known that when the Young's modulus of the lens is less than 2.0 MPa, the problem of lens discomfort is solved. In Embodiment 4 of the present disclosure, the Young's modulus is not more than 1.10 MPa, and it is apparent that the lens wearing comfort of a user can be effectively improved.

Embodiment 4(second silicon compound: Formula (3))

| DMA/(DMA + NVP) % | 0 | 12.5% | 25% | 50% | 75% | 100% |
|---|---|---|---|---|---|---|
| Water content (%) | 29 | 36 | 40 | 43 | 45 | 47 |
| Young's modulus | 1.18 | 1.10 | 1.10 | 0.89 | 0.88 | 0.89 |
| (MPa) | | | | | | |
| Oxygen permeability | 59 | 53 | 50 | 47 | 45 | 45 |
| coefficient (Dk) | | | | | | |

In Embodiment 5 of the present disclosure, the constituents and weight percentages thereof in the silicone hydrogel composition and the functional groups of the second silicon compound (Formula (3)) are shown in the following table in detail.

| Embodiment 5 | Weight percentage |
|---|---|
| First silicon compound (SiGMA) | 23.4 |
| Hydrophilic monomer (HEMA) | 9.9 |
| Hydrophilic monomer | 55.0 |
| (DMA + NVP) | |
| Initiator (1173) | 0.7 |
| Second silicon compound | 11.7 |
| (Formula (3)) | |
| Rl | CH₃ |
| R2 | OCH₂CH₂NHCOO |
| R3 | CH₃ |
| R4 | CH₃ |
| R5 | CH₃ |
| R6 | CH₃ |
| R7 | C₄H₈ |
| A | OOCNH—R7—NHCOO |
| m | 1 |
| n | 3 |
| i | 20 |
| j | 2 |

In Embodiment 5 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 5 was used, and when the weight percentage of DMA to (DMA+NVP) is controlled to be more than 12.5%, the water content of the lens was not less than 43%, the Young's modulus of the lens was not more than 0.66 MPa, and the Dk value of the lens was not less than 53. It is known that when the Young's modulus of the lens is less than 2.0 MPa, the problem of lens discomfort is solved. In Embodiment 5 of the present disclosure, the Young's modulus is not more than 0.66 MPa, and it is apparent that the lens wearing comfort of a user can be effectively improved.

Embodiment 5 (second silicon compound: Formula (3))

| DMA/(DMA + NVP) % | 0 | 12.5% | 25% | 50% | 75% | 100% |
|---|---|---|---|---|---|---|
| Water content (%) | 36 | 43 | 46 | 50 | 52 | 54 |
| Young's modulus | 0.73 | 0.66 | 0.61 | 0.54 | 0.52 | 0.47 |
| (MPa) | | | | | | |
| Oxygen permeability | 73 | 63 | 58 | 53 | 57 | 60 |
| coefficient (Dk) | | | | | | |

In Embodiment 6 of the present disclosure, the constituents and weight percentages thereof in the silicone hydrogel composition and the functional groups of the second silicon compound (Formula (3)) are shown in the following table in detail.

| Embodiment 6 | Weight percentage |
|---|---|
| First silicon compound (SiGMA) | 29.4 |
| Hydrophilic monomer (HEMA) | 13.4 |
| Hydrophilic monomer | 47.4 |
| (DMA + NVP) | |
| Initiator (1173) | 0.7 |
| Second silicon compound | 9.8 |
| (Formula(3)) | |
| Rl | CH₃ |
| R2 | OCH₂CH₂NHCOO |
| R3 | CH₃ |
| R4 | CH₃ |
| R5 | CH₃ |
| R6 | CH₃ |
| R7 | C₆H₁₂ |
| A | OOCNH—R7—NHCOO |
| m | 1 |
| n | 3 |
| i | 9 |
| j | 3 |

In Embodiment 6 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 6 was used, and when the weight percentage of DMA to (DMA+N VP) is controlled to be more than 12.5%, the water content of the lens was not less than 42%, the Young's modulus of the lens was not more than 0.65 MPa, and the Dk value of the lens was not less than 50. It is known that when the Young's modulus of the lens is less than 2.0 MPa, the problem of lens discomfort is solved. In Embodiment 6 of the present disclosure, the Young's modulus is not more than 0.65 MPa, and it is apparent that the lens wearing comfort of a user can be effectively improved.

Embodiment 6 (second silicon compound: Formula (3))

| DMA/(DMA + NVP) % | 0 | 12.5% | 25% | 50% | 75% | 100% |
|---|---|---|---|---|---|---|
| Water content (%) | 36 | 42 | 45 | 47 | 49 | 51 |
| Young's modulus | 0.67 | 0.65 | 0.64 | 0.54 | 0.59 | 0.40 |
| (MPa) | | | | | | |
| Oxygen permeability | 61 | 55 | 50 | 53 | 54 | 54 |
| coefficient (Dk) | | | | | | |

In Embodiment 7 of the present disclosure, the constituents and weight percentages thereof in the silicone hydrogel composition and the functional groups of the second silicon compound (Formula (4)) are shown in the following table in detail.

| Embodiment 7 | Weight percentage |
|---|---|
| First silicon compound (SiGMA) | 27.1 |
| Hydrophilic monomer (HEMA) | 11.4 |
| Hydrophilic monomer | 53.5 |
| (DMA + NVP) | |
| Initiator (1173) | 0.7 |
| Second silicon compound | 8.2 |
| (Formula (4)) | |
| R1 | H |
| R2 | O |
| R3 | CH₃ |
| R4 | CH₃ |
| R5 | CH₃ |
| R6 | CH₃ |
| m | 16 |
| n | 3 |
| i | 8 |

In Embodiment 7 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 7 was used, and when the weight percentage of DMA to (DMA+NVP) is controlled to be more than 12.5%, the water content of the lens was not less than 60%, the Young's modulus of the lens was not more than 0.41 MPa, and the Dk value of the lens was not less than 55. It is known that when the Young's modulus of the lens is less than 2.0 MPa, the problem of lens discomfort is solved. In Embodiment 7 of the present disclosure, the Young's modulus is not more than 0.41 MPa, and it is apparent that the lens wearing comfort of a user can be effectively improved.

Embodiment 7 (second silicon compound: Formula (4))

| DMA/(DMA + NVP) % | 0 | 12.5% | 25% | 50% | 75% | 100% |
|---|---|---|---|---|---|---|
| Water content (%) | 55 | 60 | 62 | 63 | 65 | 68 |
| Young's modulus | 0.47 | 0.41 | 0.38 | 0.30 | 0.24 | 0.20 |
| (MPa) | | | | | | |
| Oxygen permeability | 61 | 58 | 57 | 57 | 56 | 55 |
| coefficient (Dk) | | | | | | |

In Embodiment 8 of the present disclosure, the constituents and weight percentages thereof in the silicone hydrogel composition and the functional groups of the second silicon compound (Formula (5)) are shown in the following table in detail.

| Embodiment 8 | Weight percentage |
|---|---|
| First silicon compound (SiGMA) | 27.5 |
| Hydrophilic monomer (HEMA) | 12.2 |
| Hydrophilic monomer | 49.7 |
| (DMA + NVP) | |
| Initiator (1173) | 0.7 |
| Second silicon compound | 10.6 |
| (Formula(5)) | |
| R1 | CH₃ |
| R2 | O |
| R3 | CH₃ |
| R4 | CH₃ |
| R5 | CH₃ |
| R6 | CH₃ |
| n | 3 |
| i | 9 |

In Embodiment 8 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 8 was used, and when the weight percentage of DMA to (DMA+NVP) is controlled to be more than 12.5%, the water content of the lens was not less than 41%, the Young's modulus of the lens was not more than 1.20 MPa, and the Dk value of the lens was not less than 47. It is known that when the Young's modulus of the lens is less than 2.0 MPa, the problem of lens discomfort is solved. In Embodiment 8 of the present disclosure, the Young's modulus is not more than 1.20 MPa, and it is apparent that the lens wearing comfort of a user can be effectively improved.

Embodiment 8(second silicon compound: Formula(5))

| DMA/(DMA + NVP) % | 0 | 12.5% | 25% | 50% | 75% | 100% |
|---|---|---|---|---|---|---|
| Water content(%) | 36 | 41 | 43 | 45 | 46 | 48 |
| Young's modulus | 1.33 | 1.20 | 1.07 | 1.10 | 0.94 | 0.81 |
| (MPa) | | | | | | |
| Oxygen permeability | 51 | 49 | 47 | 48 | 48 | 50 |
| coefficient (Dk) | | | | | | |

In Embodiment 9 of the present disclosure, the constituents and weight percentages thereof in the silicone hydrogel composition and the functional groups of the second silicon compound (Formula (1)) are shown in the following table in detail.

| Embodiment 9 | Weight percentage |
|---|---|
| First silicon compound (SiGMA) | 24.5 |
| Hydrophilic monomer (HEMA) | 14.2 |
| Hydrophilic monomer | 44.7 |
| (DMA + NVP) | |
| Crosslinking agent (EGDMA) | 1.0 |
| Initiator (1173) | 0.7 |
| Second silicon compound | 15.6 |
| (Formula (1)) | |
| R1 | CH₃ |
| R2 | O |
| R3 | CH₃ |
| R4 | CH₃ |
| R5 | CH₃ |
| R6 | CH₃ |
| n | 3 |
| i | 10 |

In Embodiment 9 of the present disclosure, the weight percentages of the hydrophilic monomers DMA and NVP in the silicone hydrogel composition were varied, and as shown in the following table, the water content, Young's modulus and oxygen permeability coefficient of the lens were measured. The lens made of the silicone hydrogel composition of Embodiment 9 was used, and when the weight percentage of DMA to (DMA+NVP) is controlled to be more than 12.5%, the water content of the lens was not less than 48%, the Young's modulus of the lens was not more than 0.70 MPa, and the Dk value of the lens was not less than 80. It is known that when the Young's modulus of the lens is less than 2.0 MPa, the problem of lens discomfort is solved. In Embodiment 9 of the present disclosure, the Young's modulus is not more than 0.70 MPa, and it is apparent that the lens wearing comfort of a user can be effectively improved.

Embodiment 9(second silicon compound: Formula (1))

| DMA/(DMA + NVP) % | 0 | 12.5% | 25% | 50% | 75% | 100% |
|---|---|---|---|---|---|---|
| Water content (%) | 35 | 48 | 50 | 51 | 51 | 52 |
| Young's modulus | 0.90 | 0.70 | 0.44 | 0.37 | 0.34 | 0.30 |
| (MPa) | | | | | | |
| Oxygen permeability | 84 | 81 | 95 | 84 | 83 | 80 |
| coefficient (Dk) | | | | | | |

An embodiment of the present disclosure discloses a silicone hydrogel composition including a hydrophilic monomer and a first silicon compound, wherein the hydrophilic monomer is selected from the group consisting of N,N-dimethylacrylamide (DMA), N-vinylpyrrolidone (NVP) and 2-hydroxyethyl methacrylate (HEMA), wherein the first silicon compound is (3-methacryloxy-2-hydroxypropoxy)propylbis(trimethylsiloxy)methylsilane (SiGMA), wherein the weight percentage of the hydrophilic monomer is 25% to 70%, and the weight percentage of the first silicon compound is 5% to 50%, and wherein in the hydrophilic monomer, the weight percentage of the total amount of N-vinylpyrrolidone and N,N-dimethylacrylamide is 25% to 55%.

In an embodiment of the present disclosure, the lens is made by using the silicone hydrogel composition in the embodiment of the present disclosure, wherein the weight percentage of DMA to (DMA+NVP) is controlled to be more than 12.5%, the water content of the lens is more than 34%, the Young's modulus of the less is less than 2.0 MPa, and the Dk value of the lens is more than 50. Thus, when the lens is worn by a user, the lens maintains high moisture (water content) and high oxygen permeability (Dk, oxygen permeability coefficient), and the low Young's modulus of the lens can also effectively improve the lens wearing comfort of the user.

Although the present disclosure and its advantages have been described in detail, it should he understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A silicone hydrogel composition, comprising a hydrophilic monomer and a first silicon compound,
wherein the hydrophilic monomer is selected from the group consisting of N,N-dimethylacrylamide (DMA), N-vinylpyrrolidone (NVP) and 2-hydroxyethyl methacrylate (HEMA);
wherein the first silicon compound is (3-methacryloxy-2-hydroxypropoxy)propylbis(trimethylsiloxy)methylsilane (SiGMA);
wherein a weight percentage of the hydrophilic monomer is 25% to 70%, and a weight percentage of the first silicon compound is 5% to 50%; and
wherein in the hydrophilic monomer, a weight percentage of a total amount of N-vinylpyrrolidone and N,N-dimethylacrylamide is 25% to 55%.

2. The silicone hydrogel composition according to claim 1, further comprising a second silicon compound, which has a chemical structure of any one of formulae (1) to (5): 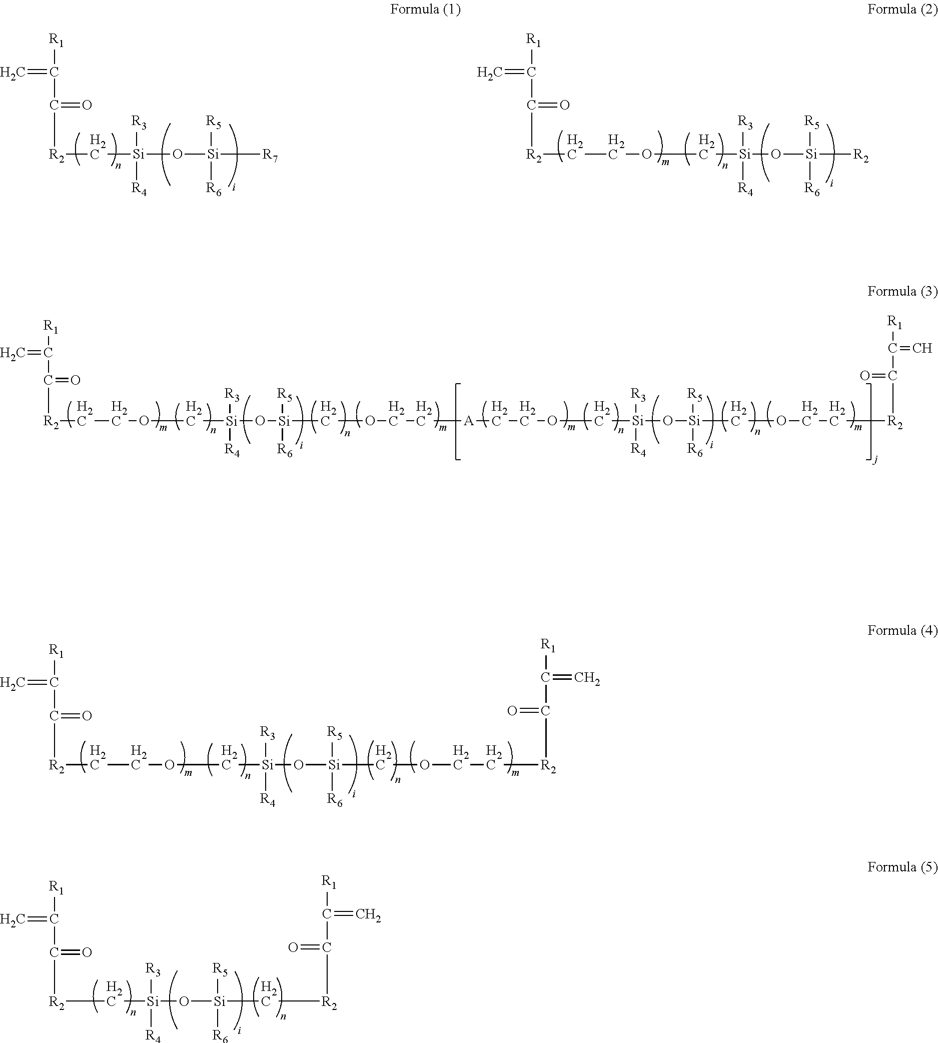
wherein A represents OOCNH—R₇—NHCOO, R₁ represents H or CH₃, R₂ represents OCH₂CH₂NHCOO or O, R₃, R₄, R₅ and R₆ represent CH₃ or OSi(CH₃)₃, R₇ represents alkyl, n is between 3 and 5, m is between 1 and 20, i is between 1 and 25, and j is between 1 and 10.

3. The silicone hydrogel composition according to claim 2, wherein a weight percentage of the second silicon compound is less than 50%.

4. The silicone hydrogel composition according to claim 1, further comprising a crosslinking agent, which is selected from the group consisting of ethylene glycol dimethacrylate, poly(diethylene glycol) dimethacrylate, triethylene glycol dimethacrylate, 1,4-butylene glycol dimethacrylate, trimethylolpropane trimethacrylate, pentaerythritol tetramethacrylate, bisphenol A dimethacrylate, methylene bismethylacrylamide, divinyl ether, divinyl sulfone, divinyl benzene, trivinyl benzene, triallyl isocyanurate, triallyl phthalate, diallyl phthalate, allyl methacrylate, and a combination thereof.

5. The silicone hydrogel composition according to claim 1, wherein a weight percentage of DMA to (DMA+NVP) is more than 12.5%.

6. The silicone hydrogel composition according to claim 1, wherein a weight percentage of DMA to (DMA+NVP) is more than 25.0%.

7. The silicone hydrogel composition according to claim 1, further comprising a colored monomer or a colored compound.

8. The silicone hydrogel composition according to claim 1, further comprising a thermal initiator, which is selected from the group consisting of azobisdimethylvaleronitrile (ADVN), 2,2′-azobisisobutyronitrile (AIBN), 2,2′-azobis(2,4-dimethylvaleronitrile), 2,2′-azobis(2-methylpropanenitrile), and 2,2′-azobis(2-methyl)valeronitrile.

9. The silicone hydrogel composition according to claim 1, further comprising a light initiator, which is selected from the group consisting of 2-hydroxy-2-methylpropiophenone, 1-hydroxycyclohexyl phenyl ketone, 2,2-dimethoxy-2-phenylacetophenone, benzoin methyl ether, and 2,2-diethoxyacetophenone.

10. A silicone hydrogel lens, which is made of the silicone hydrogel composition claimed in claim 1, and has a Young's modulus less than 2.0 MPa.

11. The silicone hydrogel lens according to claim 10, wherein the water content of the lens is not less than 34%, the Young's modulus of the lens is not more than 1.2 MPa, and the Dk value of the lens is not less than 50.

12. The silicone hydrogel lens according to claim 10, wherein the second silicon compound has a chemical structure of Formula (1), the water content of the lens is not less than 34%, the Young's modulus of the lens is not more than 1.9 MPa, and the Dk value of the lens is not less than 58.

13. The silicone hydrogel lens according to claim 10, wherein the second silicon compound has a chemical structure of Formula (2), the water content of the lens is not less than 40%, the Young's modulus of the lens is not more than 1.25 MPa, and the Dk value of the lens is not less than 76.

14. The silicone hydrogel lens according to claim 10, wherein the second silicon compound has a chemical structure of Formula (3), the water content of the lens is not less than 36%, the Young's modulus of the lens is not more than 1.10 MPa, and the Dk value of the lens is not less than 45.

15. The silicone hydrogel lens according to claim 10, wherein the second silicon compound has a chemical structure of Formula (3), the water content of the lens is not less than 43%, the Young's modulus of the lens is not more than 0.66 MPa, and the Dk value of the lens is not less than 53.

16. The silicone hydrogel lens according to claim 10, wherein the second silicon compound has a chemical structure of Formula (3), the water content of the lens is not less than 42%, the Young's modulus of the lens is not more than 0.65 MPa, and the Dk value of the lens is not less than 50.

17. The silicone hydrogel lens according to claim 10, wherein the second silicon compound has a chemical structure of Formula (4), the water content of the lens is not less than 60%, the Young's modulus of the lens is not more than 0.41 MPa, and the Dk value of the lens is not less than 55.

18. The silicone hydrogel lens according to claim 10, wherein the second silicon compound has a chemical structure of Formula (5), the water content of the lens is not less than 41%, the Young's modulus of the lens is not more than 1.20 MPa, and the Dk value of the lens is not less than 47.

19. The silicone hydrogel lens according to claim 10, wherein the second silicon compound has a chemical structure of Formula (1), the water content of the lens is not less than 48%, the Young's modulus of the lens is not more than 0.70 MPa, and the Dk value of the lens is not less than 80.
